(19) United States
(12) Patent Application Publication
(10) Pub. No.: US 2021/0309086 A1
(43) Pub. Date: Oct. 7, 2021

(54) MOLDED OUTER BELT WEATHERSTRIP

(71) Applicants: John Zimmer, Canton, MI (US); Mike Heinze, Canton, MI (US)

(72) Inventors: John Zimmer, Canton, MI (US); Mike Heinze, Canton, MI (US)

(21) Appl. No.: 12/681,249

(22) PCT Filed: Oct. 2, 2008
(86) PCT No.: PCT/US08/78556

§ 371 Date: May 19, 2011

Related U.S. Application Data
(60) Provisional application No. 60/976,821, filed on Oct. 2, 2007.

(51) Int. Cl. B60J 10/265; B60J 10/75

(52) U.S. Cl. CPC B60J 10/265; B60J 10/33; B60J 10/75

(57) ABSTRACT

A weatherstrip is adapted for use on an associated vehicle, and finds particular use as an outer belt. The two-part structure includes a molded exterior shell having integral attachment features, and integral wrapped end features that are unitarily or integrally molded with the shell. An extruded weatherstrip insert is placed within the shell and provides the desired sealing to the glass and attachment to a door flange. The molded shell reduces the need for extensive trim operations to otherwise create complex geometries, stretch bending and incorporates end attachment features while the aesthetic outer show surface may be chrome plated which leads to reduced scrap associated with the commonly-used stainless steel.

This application claims priority from U.S. provisional application Ser. No. 60/976,821, filed 2 Oct. 2007, the disclosure of which is expressly incorporated herein by reference.

### BACKGROUND OF THE INVENTION

This disclosure relates to an automotive weatherseal or weatherstrip such as an outer belt, and particularly to a weatherstrip of the type employing an aesthetic show surface. It will be appreciated that this disclosure relates to a weatherstrip that employs the benefits of extruded or coextruded structures, as well as associated benefits of a molded portion.

OEM customers prefer a wrapped end look on outer belts without a line that is typically created by separately formed outer belt end caps attached to the belt structure. This wrapped end look is particularly preferred with bright stainless steel outer belts, or outer belts of various colors and glosses that are different than the color or gloss of an underlying portion of the outer belt seal weatherstrip assembly.

For example, known construction of weatherstrips have an outer belt with a shiny or bright show surface that may be part of a thermoset (such as EPDM) or thermoplastic structure. They are often co-extruded structures in which a bright stainless steel or color show surface is coextruded as a part of the elastomeric portion of the belt seal. These types of constructions usually require extensive secondary trim operations to fit the door and thus result in a complex geometry such as notches and end cuts. The additional components such as end caps, in conjunction with the trim and assembly operations, add to the expense of the assembly. These known structures also have various quality issues such as mismatches, processing scratches, etc., along with high scrap rates.

Another current outer belt option is a stainless steel cap with formed ends (folded over ends). However, the structure is all stainless steel and is therefore expensive. Thus, a need exists for an alternative structure that may incorporate a stainless steel strip as only a part of the structure.

Although extruded weatherstrips may be simply formed as a co-extrusion, such as a rigid core encompassed in a thermoplastic or elastomeric material, the cost savings associated with the ease of assembly are sometimes outweighed by the limitations associated with a cross-sectional, extruded profile. Thus, separate end caps or end members serve both aesthetic and functional features such as limiting noise associated with a gap where no end members are present, as well as minimizing visible seams and prohibiting snagging of clothing. On the other hand, if the outer show surface of the weatherstrip is stamped, the seams can be eliminated but the associated cost is increased.

Thus, a need exists for a weatherstrip, and particularly an outer belt assembly, that produces the appearance of a molded exterior shell, that eliminates the needs for extensive trim operations incorporating attachment means, reduces scrap associated with scratching during processing, and burrs that are common with stainless steel, and allows complex geometries to be created in a cost effective manner.

### SUMMARY OF THE INVENTION

A weatherstrip for use on an associated vehicle includes a body having a gripping portion for securing the body to the vehicle. The body includes features such as a seal lip for engaging the associated movable window, a cover lip, and other seal lip portions that provide a smooth transition with the vehicle body surface. A separately molded and/or chrome plated or painted outer surface is secured to the underlying body. Molded-in end treatments are unitarily or integrally provided on opposite ends of the molded belt component and overlie opposite ends of the extruded sealing portion of the body.

A door attachment feature is preferably integrally/unitarily molded in the molded arrangement.

A method of assembling the weatherstrip includes extruding an insert which includes means for attaching the insert to a mounting flange of the vehicle. The extruded insert is placed within the exterior shell that is separately molded. The extruded insert is secured to the mounting flange, and the extruded insert also provides the desired sealing to the glass window. The molded shell eliminates the need for extensive trim operations and provides a means to attach the ends of the part to the door.

A primary benefit of the disclosure is the advantageous inclusion of both extruded and molded features of a weatherstrip.

Another benefit resides in integrated end treatments to provide a wrapped end look on the outer belt without a line.

Yet another benefit is associated with the integral fastening features for securing the assembly to the associated vehicle.

Still other features and benefits of the disclosure will become apparent to one skilled in the art upon reading and understanding the following detailed description.

### BRIEF DESCRIPTION OF THE DRAWINGS

FIG. 1 is a plan view of the outer belt assembly.

FIG. 2 is an enlarged plan view of the right-hand edge of the weatherstrip of FIG. 1.

FIG. 3 is an enlarged plan view of the left-hand end of the weatherstrip of FIG. 1.

FIG. 4 is a cross-sectional view taken generally along the lines 4-4 of FIG. 1.

### DETAILED DESCRIPTION OF THE PREFERRED EMBODIMENTS

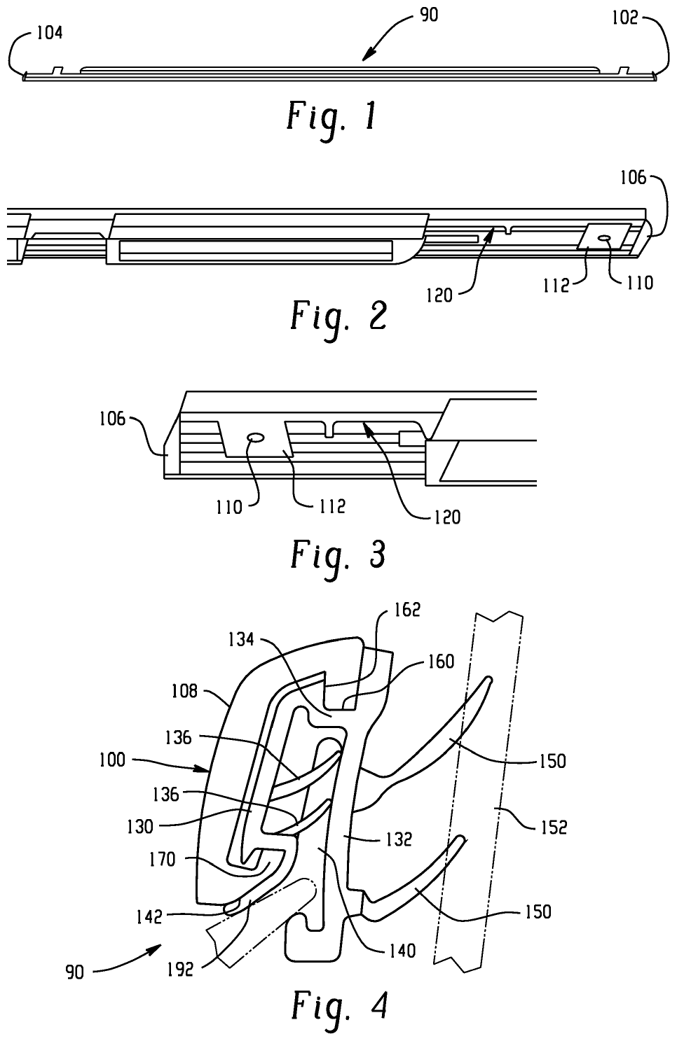

FIGS. 1-4 show a weatherseal or weatherstrip 90 for use in association with an automotive vehicle (not shown). More particularly, the weatherstrip is often referred to as an outer belt and is a weatherstrip situated at a lower portion of a window opening in a vehicle door extending from a front pillar portion to a rear pillar portion, for example from an A pillar to a B pillar on a front door, or from a B pillar to a C pillar on a rear door. The outer belt has a length dimensioned to closely match that of the linear length of the door opening along the base region of the opening in the vehicle door. In this particular embodiment, there are two primary components to the weatherstrip assembly. The first component or portion is a molded outer shell 100 having a first end 102 and a second end 104. Each end includes an end cap 106 (FIGS. 2 and 3) that is unitarily formed (unitary manufacturing operation), i.e., integrally molded, in the mold. Thus, no lines are created as are typically evident in separately created outer belt end caps that are subsequently attached to the opposite ends of a belt assembly. The end caps close the end of the weatherstrip, i.e., the end caps extend substantially perpendicular to a longitudinal extent or longitudinal axis of the weatherstrip to provide a closed end to the structure. Moreover, the molded outer shell is a durable structure such as a thermoplastic and may be painted, chrome plated, etc. along an outer or show surface 108 (FIG. 4). It will also be appreciated that the end caps need not necessarily assume a simple wall structure that extends generally perpendicular to the longitudinal extent of the weatherstrip. However, an end feature or cap structure is desired to provide a secure interfit and aesthetically pleasing appearance at the ends of the outer belt.

In addition, fastening features such as molded-in pilot holes or openings 110 in fastening or mounting flanges 112 may be provided at selected locations along the weatherstrip. Again, preferably the fastening flanges 112 are located adjacent the ends in order to align the openings with a fastener or other attachment arrangement associated in the door of the associated vehicle. As illustrated in FIGS. 1-3, the openings 110 in the flanges 112 are disposed generally perpendicular to the longitudinal extent or longitudinal axis of the weatherstrip so that the assembled weatherstrip can be secured to the door with a fastener that likewise extends generally perpendicular to the weatherstrip. By molding the flange with the openings, this orientation of the door mounting feature can be effectively incorporated into the weatherstrip and eliminates the need for extensive trim operations to create complex geometries as encountered in prior weatherstrips.

Mold-in recesses or surface irregularities 120 may also be provided in the first component. For example, recesses are disposed axially inward from each of the end caps and the fastening flanges. For example, the molded-in recesses 120 may be of the type to accommodate an appliqué, mirror sail, or associated glass run that extends vertically therethrough. Of course, recesses or similar features may be provided for still other reasons without departing from the scope and intent of the present disclosure.

Disposed in a central portion of the weatherstrip is the second component of the weatherstrip assembly, namely, an extruded body comprised of first and second legs 130, 132 that are joined together by interconnecting region 134 (FIG. 4). The extruded body may include mounting means such as one or more retention fingers 136 adapted to engage a vehicle flange such as door flange 140, usually associated with the juncture or joining of inner and outer door panels. In addition, lip 142 extends from a lower, outer end of the extrusion body and is conformed for receipt along the external surface of the outer door panel.

Extending from the second leg 132 of the extruded body are one or more seal lips 150. As is well known in the industry, the seal lips are preferably of a flexible nature and adapted to sealingly and slidably engage a surface of window 152. It is common to provide a low friction surface along the seal lips to allow the seal lips to slide relative to the window when the window is selectively raised and lowered.

The extrusion body preferably includes first and second mounting features or recesses 160, 170 that receive turned-in edges of the molded shell 162, 172, respectively. This provides a mechanical snap-fit between the extrusion body and the overlying molded shell. Thus, the extrusion body is inserted over the flange and the molded outer shell is otherwise fastened or secured to the vehicle via the pilot holes 110 and the fastening flanges 112.

The molded exterior shell with the integral pilot holes for attachment to the door is formed in one assembly operation and the separately formed extruded body or insert is subsequently placed within the shell to attach to the mounting flange and provide sealing to the glass window. The molded shell also eliminates the need for extensive trim operations to create complex geometries. The chrome plated surfaces also reduce scrap associated with scratching and burrs that are common with stainless steel processing. The wrapped ends and complex geometry may be molded into the shell with attachments at the ends and an improved overall length accuracy. Moreover, the molded outer shell can have the curvature molded therein to eliminate stretch bending operations typically associated with an extruded structure.

Preferably, the legs 130, 132 and interconnecting portion 134 of the extruded body are formed from a more rigid polypropylene, while the seal lips, retention fingers, and lip 142 are formed from a more flexible material such as a TPV. The molded outer shell can be formed from a variety of materials, preferably a material that provides for desired gloss, painted surface features, or ease of chrome plating. Of course these are representative materials only, and the present disclosure should not be so limited unless specifically claimed.

The invention has been described with reference to the preferred embodiment. Obviously, modifications and alterations will be apparent to those skilled in the art upon reading and understanding the preceding detailed description. However, the present disclosure should be construed as including all such modifications and alterations.

Having thus described the invention, it is now claimed:

1. A weatherstrip for use on an associated vehicle comprises:
a body having a gripping portion for securing the body to the vehicle; and
a molded shell secured to the underlying body having molded-in end caps adjacent opposite ends of the molded shell.

2. The weatherstrip of claim 1 wherein the molded-in end caps are unitary with the shell.

3. The weatherstrip of claim 2 wherein the molded-in end caps are provided on opposite ends of the molded shell and extend substantially perpendicular to an elongated axis of the weatherstrip.

4. The weatherstrip of claim 1 wherein the molded-in end caps overlie opposite ends of the extruded sealing portion of the body without a transition line with the remainder of the molded shell.

5. The weatherstrip of claim 1 wherein the body includes a seal lip dimensioned to engage an associated movable window of the associated vehicle.

6. The weatherstrip of claim 5 wherein the body includes a retaining member for gripping engagement with an associated vehicle flange.

7. The weatherstrip of claim 1 wherein the molded shell includes one of a chrome plated or painted outer surface.

8. The weatherstrip of claim 1 wherein the molded shell includes a door attachment feature provided therein, the door attachment feature including an opening that extends substantially perpendicular to an elongated axis of the weatherstrip.

9. The weatherstrip of claim 1 wherein the molded shell includes a recess dimensioned to closely receive an associated intersecting vehicle component.

10. A method of assembling a weatherstrip for an associated vehicle comprising:
extruding a body;
molding a shell dimensioned for at least partial receipt of the body therein; and
mounting the shell to the body.

11. The method of claim 10 further comprising providing means for attaching the insert to a mounting flange of the vehicle.

12. The method of claim 11 wherein the molding step includes providing a door attachment feature on the molded shell.

13. The method of claim 10 wherein the molding step includes providing a door attachment feature on the molded shell.

14. The method of claim 10 wherein the providing step includes creating mounting flanges on the shell.

15. The method of claim 14 further comprising forming a mounting opening in each flange.

16. The method of claim 15 further comprising orienting the mounting flange opening to extend substantially perpendicular to an elongated axis of the weatherstrip.

17. The method of claim 10 wherein the molding step includes forming end caps.

18. The method of claim 17 wherein the end cap forming step includes orienting the end caps substantially perpendicular to an elongated axis of the weatherstrip.

19. The method of claim 10 wherein the body extruding step includes forming at least one sealing lip dimensioned to engage an associated vehicle window.

20. The method of claim 19 wherein the forming step includes using a different material for the sealing lip than a material used for a remainder of the body.
